(19) United States
(12) Patent Application Publication
(10) Pub. No.: US 2006/0133222 A1
(43) Pub. Date: Jun. 22, 2006

(54) LITHOGRAPHY METHOD

(76) Inventor: Benjamin Szu-Min Lin, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/905,265

(22) Filed: Dec. 22, 2004

(51) Int. Cl. G11B 21/08

(52) U.S. Cl. 369/30.01; 369/112.19

(57) ABSTRACT

A lithography method for improving contrast includes the following steps: To provide a light source. To provide a first plate including at least one opening rotates according to at least one angular velocity. To provide a mask having patterns on it. To provide a second plate including at least one block corresponding to the opening rotates according to the same angular velocity as the first plate. The method also includes a step to perform an exposure process such that zero order light diffracted by the mask is hindered by the block.

### BACKGROUND OF INVENTION

1. Field of the Invention

The present invention relates to a lithography method, and more particularly, to a lithography method utilizing a designed coherent plate in conjunction with a matching diffraction plate to form patterns having a superior contrast in a photoresist layer.

2. Description of the Prior Art

In integrated circuit manufacturing processes, a lithographic process has become a mandatory technique. In a lithographic process, a designed pattern, such as a circuit pattern, a doping pattern, a contact hole pattern, or a trench pattern, is created on one or several photo masks, then the pattern on the photo mask is transferred by light exposure, with a stepper or a scanner, into a photoresist layer on a semiconductor wafer. Only by using a lithographic process can a wafer producer precisely and clearly transfer a complicated circuit pattern onto a semiconductor wafer.

It is an important issue for solving resolution of the lithographic process due to the reducing device sizes of the semiconductor industry. Theoretically, using short wavelengths of light to expose a photoresist layer will improve the resolution right away. Short wavelengths of light are desirable as the shorter the wavelength, the higher the possible resolution of the pattern. This method, though it seems simple, is not feasible. First, light sources for providing short wavelengths of light are not accessible. Secondly, the damage of equipment is very considerable when short wavelengths of light is used to expose a photoresist layer, leading to a shorted equipment lifetime. The cost is thus raised, which makes products not competitive. Due to the conflicts between theory and practice used in manufacturing, the manufacturers are all devoted to various researches so as to overcome this problem.

Please refer to FIG. 1, FIG. 1 is a schematic diagram illustrating a lithography method according to the prior art. As shown in FIG. 1, light beams originating from a light source 12 pass through a coherent plane 14 first, then evenly illuminate a mask 16 having patterns 18 on it. Diffraction effects thus occur because the patterns 18 on the mask 16 hinder incident light. The coherent plane 14 is usually a lens. However, after light passing through the lens, the original function of space variables g(x,y,z) is transformed to a function of angular spatial frequencies G(fₓ,f_{y},f_{z}) by a Fourier transformation (G(fₓ,f_{y},f_{z})=F{g(x,y,z)}.

Please refer to FIG. 2, FIG. 2 is a schematic diagram illustrating the types of light functions before and after a Fourier transformation. In order to facilitate illustration, the zero order light and the ±first order light are both shown in FIG. 2. However, the ±first order light is not separated out until the incident light is diffracted by the patterns 18. As shown in FIG. 2, the types of these two functions are different from each other although they both represent light intensity. Later, the even incident light diffracted by the patterns 18 is separated into diffraction light of different orders.

Please refer back to FIG. 1, the diffraction light of different orders is thereafter incident upon a diffraction plane 22 of projection lens 24 to allow the projection lens 24 to collect the diffraction light of different orders and to focus them on a wafer 26. The diffraction plane 22 is usually a lens. After light passing through the lens, the transformed function of angular spatial frequencies G(fₓ,f_{y},f_{z}) is transformed back to another function of space variables g′(x,y,z) by another Fourier transformation (g′(x,y,z)=F{G(fₓ,f_{y},f_{z})}, and the type of g′(x,y,z) is the same as that of g(x,y,z). Similarly, the types of these two functions are different from each other although they both represent light intensity.

Please refer to FIG. 1 and FIG. 3, FIG. 3 is a schematic diagram illustrating light of different orders collected by a numeric aperture 28. As shown in FIG. 3, the zero order light and part of the ±first order light are collected by the numeric aperture (NA) 28 of the projection lens 24 after this Fourier transformation, and are focused to the wafer 26. However, the smaller the critical dimension (CD) is, the larger the diffraction angle of the incident light is with the same exposure light source. That means, when the critical dimension of the patterns 18 is very small, the diffraction angle is large to cause a large period of the zero order light (ΔP, as shown in FIG. 2). Please refer to FIG. 4, FIG. 4 is an image intensity versus position curve acquired by performing the prior art lithography method. As shown in FIG. 4, the resulted curve is formed by adding up the intensity of the zero order light, partial of the +first order light, and partial of the −first order light. It is worth noting that the resulted curve has an Iₘᵢₙ not equal to zero due to the existence of the zero order light.

Since the contrast of an image is defined as C=(Iₘₐₓ−Iₘᵢₙ)/(Iₘₐₓ+Iₘᵢₙ), the smaller the Iₘᵢₙ is, the higher the contrast is. Once the Iₘᵢₙ is high, the image contrast is poor, leading to unsatisfied resolution. Actually, the zero order light, becoming a constant in a Fourier transform series, does not carry any pattern signals. Rather, it represents the background intensity (Iₘᵢₙ). That means, in order to obtain an increased contrast and a satisfied resolution, the zero order light needs to be eliminated.

Therefore, it is very important to develop a lithography method to eliminate the zero order light so as to effectively improve the contrast and resolution of the patterns. This method is able to be applied to small-sized patterns, and should not damage equipment when using the current equipment. In addition, this method should not add any difficulty and complexity to routine processing, and should be implanted to the production line very easily without causing extra labor cost.

### SUMMARY OF INVENTION

It is therefore an objective of the claimed invention to provide a lithography method utilizing a designed coherent plate in conjunction with a matching diffraction plate to resolve the above-mentioned problem.

According to the claimed invention, a lithography method for improving contrast comprising eliminating zero order light by utilizing a first plate in conjunction with a matching second plate is provided. The method comprises the following steps: To provide a light source. To provide a first plate comprising at least one opening rotates according to at least one angular velocity. To provide a mask having patterns on it. To provide a second plate comprising at least one block corresponding to the opening rotates according to the same angular velocity as the first plate. The method also comprises a step to perform an exposure process such that the zero order light diffracted by the mask is hindered by the block.

The present invention method for improving the contrast of patterns utilizes a designed coherent plane in conjunction with a matching diffraction plane. The background intensity (Iₘᵢₙ) is therefore zero by effectively eliminating the zero order light, which becomes a constant in a Fourier transform series and does not carry any pattern signals. The contrast of patterns is thus increased to improve the resolution of patterns. In summary, the present invention method can be applied to small-sized patterns, and does not damage equipment when using the current equipment. In addition, the present invention method does not add any difficulty and complexity to routine processing, and can be implanted to the production line very easily without causing extra labor cost.

These and other objectives of the claimed invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 is a schematic diagram illustrating a lithography method according to the prior art.

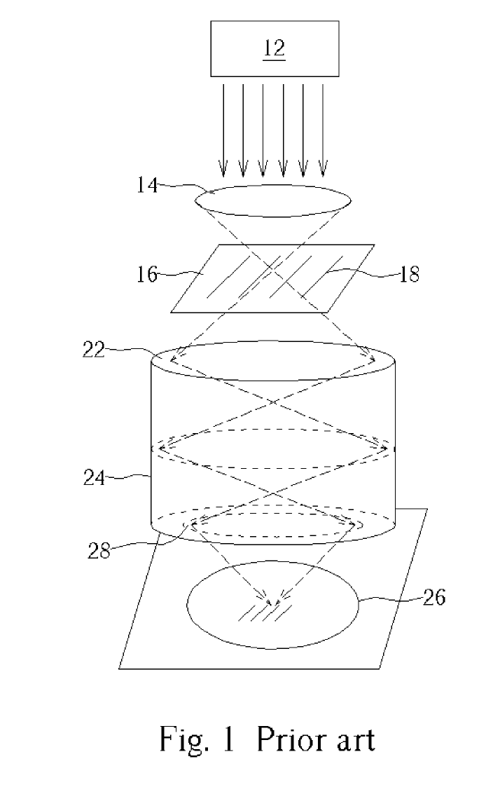

FIG. 2 is a schematic diagram illustrating the types of light functions before and after a Fourier transformation.

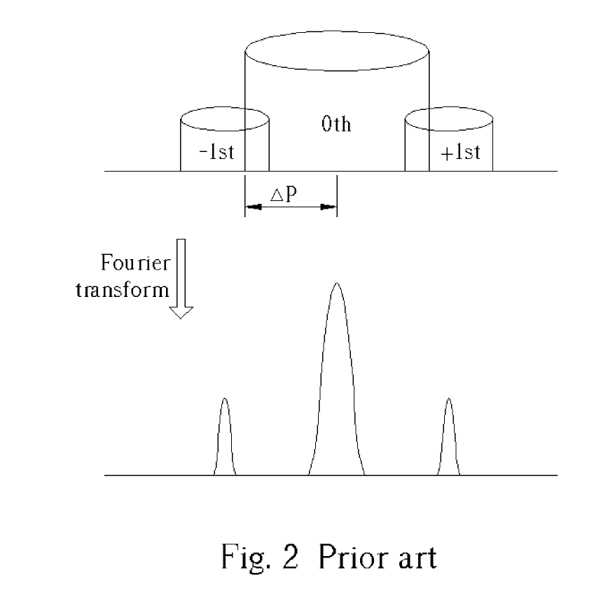

FIG. 3 is a schematic diagram illustrating light of different orders collected by a numeric aperture.

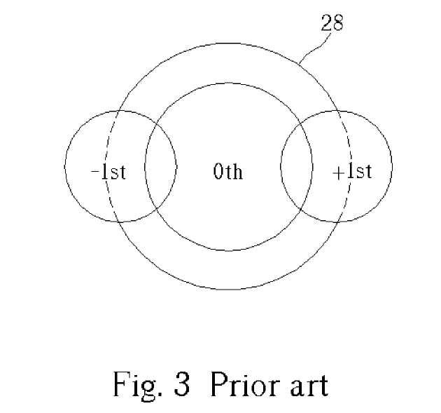

FIG. 4 is an image intensity versus position curve acquired by performing the prior art lithography method.

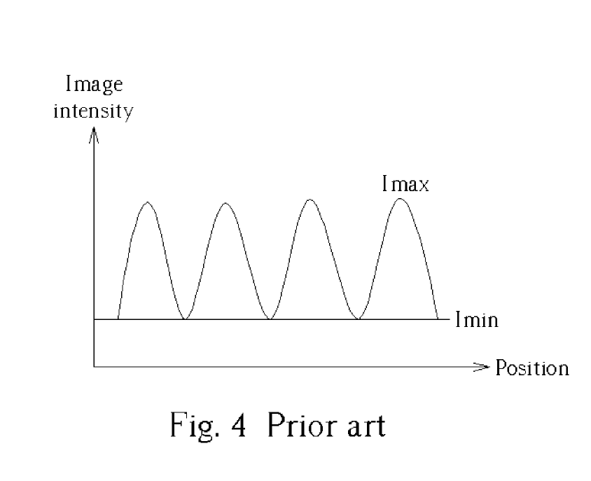

FIG. 5 is a schematic diagram illustrating a lithography method according to the present invention.

FIG. 6 is a schematic diagram illustrating a coherent plane according to a first preferred embodiment of the present invention.

FIG. 7 is a schematic diagram illustrating the working principle of the present invention method.

FIG. 8 is a schematic diagram illustrating light of different orders collected by a numeric aperture.

FIG. 9 is an image intensity versus position curve acquired by performing the present invention lithography method.

FIG. 10 is a schematic diagram illustrating a coherent plane according to a second preferred embodiment of the present invention.

### DETAILED DESCRIPTION

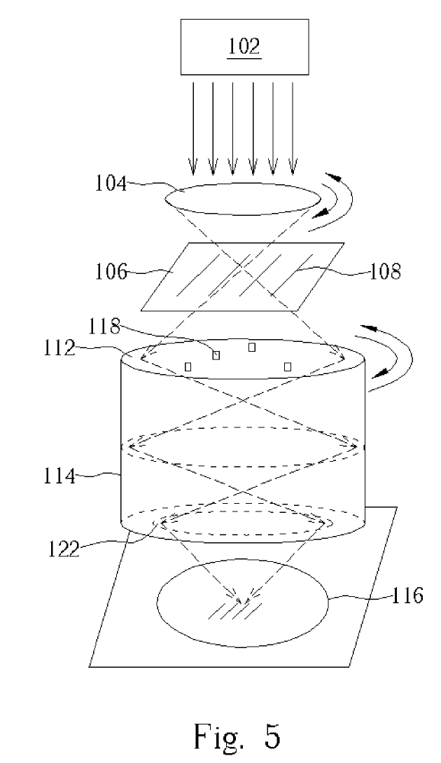

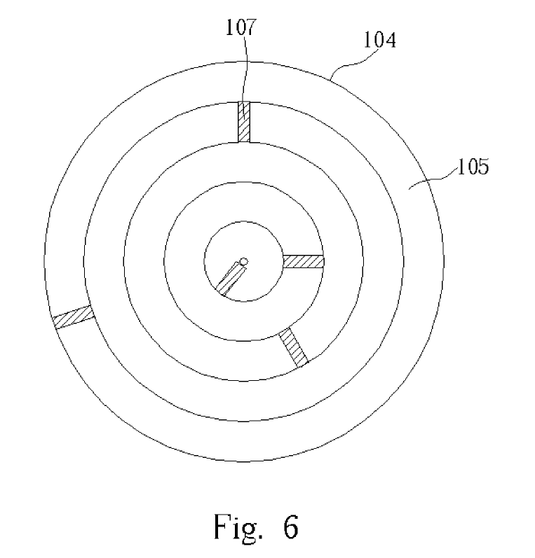

Please refer to FIG. 5 and FIG. 6, FIG. 5 is a schematic diagram illustrating a lithography method according to the present invention, FIG. 6 is a schematic diagram illustrating a coherent plane 104 according to a first preferred embodiment of the present invention. As shown in FIG. 5, light beams originating from a light source 102 pass through a coherent plane 104 first. As shown in FIG. 6, a plurality of concentric ring-shaped regions 105 are included in the coherent plane 104, and the plurality of concentric ring-shaped regions 105 take a center of the coherent plane 104 as center points. Each of the ring-shaped regions 105 comprises at least one opening 107 in a slit shape. The opening 107 in each of the ring-shaped regions 105 is interlaced with each opening 107 in each other ring-shaped region 105. The coherent plane 104 rotates according to at least one angular velocity.

Actually, the coherent plane 104 may have different designs, not limited in the design shown in FIG. 6. The coherent plane 104 may comprise only one ring-shaped region 105 taking a center of the coherent plane 104 as a center point, and the ring-shaped region 105 comprises at least one opening 107 in a slit shape. No matter how, light beams originating from the light source 102 pass through the openings 107 to form small partial coherent illumination. The coherent plane 104 may be a lens stacked with a baffle plate or other apparatus.

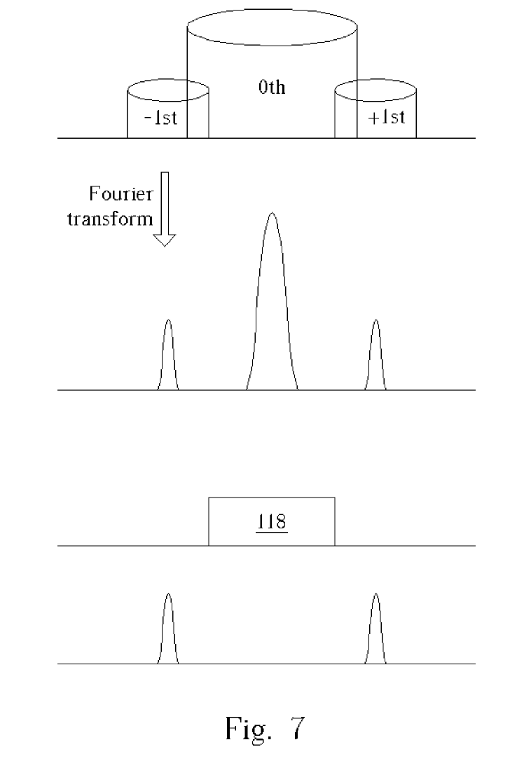

However, after light passing through the coherent plane, the original functions of space variables g₁(x,y,z), g₂(x,y,z), g₃ (x,y,z), etc. are transformed to functions of angular spatial frequencies G₁(fₓ,f_{y},f_{z}), G₂(fₓ,f_{y},f_{z}), G₃(fₓ,f_{y},f_{z}), etc., respectively, by Fourier transformations (G₁(fₓ,f_{y},f_{z})=F{g₁(x,y,z), G₂(fₓ,f_{y},f_{z})=F{g₂(x,y,z), etc.}. Please refer to FIG. 7, FIG. 7 is a schematic diagram illustrating the working principle of the present invention method. As shown in FIG. 7, the types of light functions before and after passing the coherent plane 104 are different from each other, by taking one of the functions as an example, although they both represent light intensity. In order to facilitate illustration, the zero order light and the ±first order light are both shown in FIG. 7 at the beginning. However, the ±first order light is not separated out until the incident light is diffracted by the patterns 108 (as shown in FIG. 5).

Please refer back to FIG. 5, light beams passing through the coherent plane 104 then evenly illuminate a mask 106 having patterns 108 on it. Diffraction effects thus occur because the patterns 108 on the mask 106 hinder incident light. Later, the even incident light diffracted by the patterns 108 is separated into diffraction light of different orders. The diffraction light of different orders is thereafter incident upon a diffraction plane 112 of projection lens 114 to allow the projection lens 114 to collect the diffraction light of different orders and to focus them on a wafer 116.

A plurality of blocks 118 which are corresponding to the openings 107 are included in the diffraction plane, and the diffraction plane 112 rotates according to the same angular velocity as the coherent plane 104. Since the site and dimensions of each of the blocks 118 are decided through sophisticated calculation by a computer, the unwanted light can be hindered by the blocks 118. In the present invention method, each of the blocks 118 hinders the zero order light passing through the corresponding opening 107, as shown in FIG. 7. The diffraction plane 112 may be a lens stacked with a baffle plate or other apparatus. Actually, each of the blocks may be regarded as a filter in this optical system. Furthermore, any design with which light beams passing through the coherent plane can evenly illuminate the mask, and the first order light diffracted by the mask can be eliminated effectively is within the scope of the present invention method.

Later, the transformed functions of angular spatial frequencies G₁(fₓ,f_{y},f_{z}), G₂(fₓ,f_{y},f_{z}), G₃(fₓ,f_{y},f_{z}), etc. are transformed back to functions of space variables g₁′(x,y,z), g₁′(x,y,z), g₁′(x,y,z), etc., respectively, by Fourier transformations (g₁′(x,y,z)=F{G₁(fₓ,f_{y},f_{z}), g₂′(x,y,z)=F{G₂(fₓ,f_{y},f_{z}), etc.} after light passing through the diffraction plane 112. The type of g₁(x,y,z) is the same as that of g₁′(x,y,z). Similarly, the types of the functions before and after passing through the diffraction plane 112 are different from each other although they both represent light intensity. Since each of the blocks 118 hinders the zero order light passing through the corresponding opening 107 as mentioned previously, some of the light disappears.

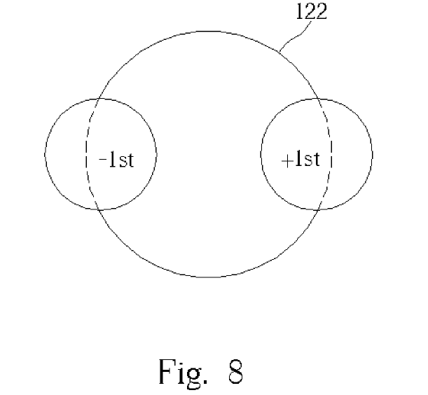

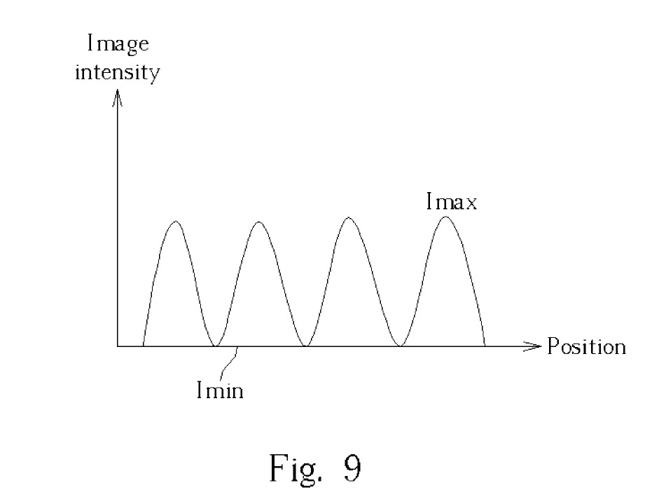

Please refer to FIG. 8, FIG. 8 is a schematic diagram illustrating light of different orders collected by a numeric aperture 122. As shown in FIG. 8, the zero order light is eliminated. Therefore, part of the +first order light and the −first order light are collected by the numeric aperture 122 of the projection lens 114 and are focused to the wafer 116. Please refer to FIG. 9, FIG. 9 is an image intensity versus position curve acquired by performing the present invention lithography method. As shown in FIG. 9, the resulted curve is formed by adding up the intensity of partial of the +first order light and partial of the −first order light. It is worth noting that the resulted curve has an Iₘᵢₙ equal to zero due to the eliminating of the zero order light. Actually, the zero order light, becoming a constant in a Fourier transform series, does not carry any pattern signals. Therefore, no pattern signal are lost when the background intensity (Iₘᵢₙ) is zero. As a result, patterns (not shown) having a superior contrast are formed in a photoresist layer (not shown) on the wafer 116.

Since the contrast of a image is defined as C=(Iₘₐₓ−Iₘᵢₙ)/(Iₘₐₓ+Iₘᵢₙ), the smaller the Iₘᵢₙ is, the higher the contrast is. When the Iₘᵢₙ is equal to zero, a superior image contrast is resulted in, leading to a satisfied resolution.

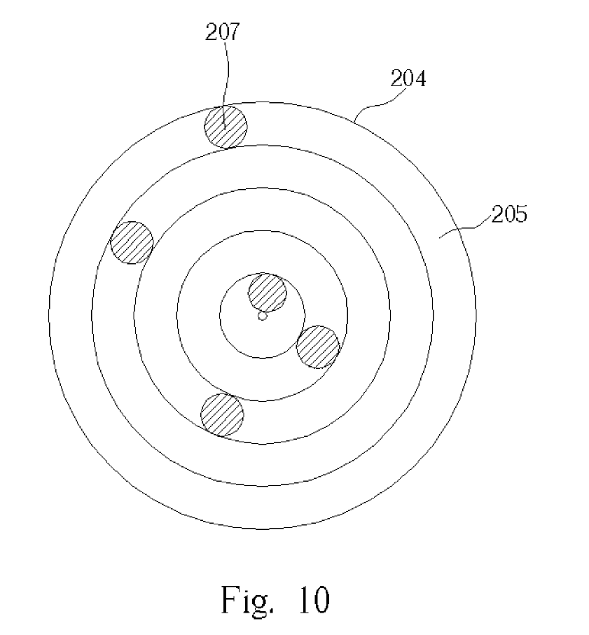

Please refer to FIG. 10, FIG. 10 is a schematic diagram illustrating a coherent plane 204 according to a second preferred embodiment of the present invention. The only difference between the first preferred embodiment and the second preferred embodiment is the shape of the opening. As shown in FIG. 10, a plurality of concentric ring-shaped regions 205 are included in the coherent plane 204, and the plurality of concentric ring-shaped regions 205 take a center of the coherent plane 204 as center points. Each of the ring-shaped regions 205 comprises at least one opening 207 in a circular shape. The opening 207 in each of the ring-shaped regions 205 is interlaced with each opening 207 in each other ring-shaped region 205. Therefore, light beams originating from the light source (not shown) pass through the openings 207 to form small partial coherent illumination. Actually, different pupil functions (P) are involved in the calculation when the openings 107, 207 are in different shapes. Since the working principle in other portions of the second preferred embodiment is the same as that of the first preferred embodiment, it is not mentioned redundantly.

It is worth noting that the center point of the coherent plane is not light transmitting. In Fourier transformation, the maximum value occurs at the origin (x=0, y=0). The center point thus becomes a very bright spot. Under the circumstances, the center point is designed as not light transmitting to avoid uneven illumination and unwanted light revealing. In addition, the light source may comprise an on-axis illumination light source, such as a circular illumination, or an off-axis illumination light source, such as an annular illumination, a dipole illumination, a tripole illumination, or a quadruple illumination. Although different illumination methods will provide different illumination patterns, the same working principle is employed. No matter what kind of illumination method is utilized, the diffraction plane in conjunction with the designed coherent plane can be found out through sophisticate calculation.

The present invention lithography method, used for improving contrast of patterns, utilizes a designed coherent plane in conjunction with a matching diffraction plane. Therefore, the zero order light is eliminated to result in an Iₘᵢₙ equal to zero, leading to a superior image contrast. When applying the present invention method to a practical production line, the resolution of patterns is improved. The equipment is not damaged. Furthermore, the processing complexity and labor cost are not increased.

In contrast to the prior art method, the present invention method utilizes a designed coherent plane in conjunction with a matching diffraction plane. By effectively eliminating the zero order light, which becomes a constant in a Fourier transform series and does not carry any pattern signals, the background intensity (Iₘᵢₙ) is zero. The contrast of patterns is thus increased to improve the resolution of patterns. In summary, the present invention method is able to be applied to small-sized patterns, and does not damage equipment when using the current equipment. In addition, the present invention method does not add any difficulty and complexity to routine processing, and can be implanted to the production line very easily without causing extra labor cost.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A lithography method for improving contrast comprising eliminating zero order light by utilizing a first plate in conjunction with a matching second plate.

2. The method of claim 1 comprising the following steps:
providing a light source;
providing a first plate comprising at least one opening, and the first plate rotating according to at least one angular velocity;
providing a mask having patterns on it;
providing a second plate comprising at least one block corresponding to the opening, and the second plate rotating according to the same angular velocity as the first plate; and
performing an exposure process such that the zero order light diffracted by the mask is hindered_by the block.

3. The method of claim 2 wherein the first plate is positioned underneath the light source, the mask is positioned underneath the first plate, and the second plate is positioned underneath the mask.

4. The method of claim 2 wherein the light source comprises a circular illumination, an annular illumination, a dipole illumination, a tripole illumination, or a quadruple illumination.

5. The method of claim 2 wherein the first plate is a coherent plane, and the second plate is a diffraction plane.

6. The method of claim 2 wherein the opening is included in a ring-shaped region by taking a center of the first plate as a center point.

7. The method of claim 2 wherein the first plate comprises a plurality of openings, the openings are included in a plurality of concentric ring-shaped regions by taking a center of the first plate as center points, and each opening in each of the ring-shaped regions is interlaced with each opening in each other ring-shaped region.

8. The method of claim 2 wherein each of the openings is in a slit shape or in a circular shape.

9. The method of claim 2 wherein the center of the first plate is not light transmitting.

10. The method of claim 2 wherein the block is a filter.

11. A lithography method for improving contrast comprising the following steps:
providing a light source;
providing a first plate comprising a plurality of concentric ring-shaped regions by taking a center of the first plate as center points, each of the ring-shaped regions comprising at least one opening, the opening in each of the ring-shaped regions being interlaced with the opening in each other ring-shaped region, and the first plate rotating according to at least one angular velocity;
providing a mask having patterns on it;
providing a second plate comprising a plurality of blocks corresponding to the openings, and the second plate rotating according to the same angular velocity as the first plate; and
performing an exposure process such that zero order light diffracted by the mask is hindered by the blocks.

12. The method of claim 11 wherein the first plate is positioned underneath the light source, the mask is positioned underneath the first plate, and the second plate is positioned underneath the mask.

13. The method of claim 11 wherein the light source is an on-axis illumination light source, and the light source is a circular illumination.

14. The method of claim 11 wherein the light source is an off-axis illumination light source, and the light source comprises an annular illumination, a dipole illumination, a tripole illumination, or a quadruple illumination.

15. The method of claim 11 wherein the first plate is a coherent plane.

16. The method of claim 11 wherein each of the openings is in a slit shape or in a circular shape.

17. The method of claim 11 wherein the center of the first plate is not light transmitting.

18. The method of claim 11 wherein each of the patterns comprises a contact hole pattern, a trench pattern, a metal line pattern, an island pattern, a memory cell pattern of a memory array, or a logic cell pattern of a logic circuit.

19. The method of claim 11 wherein the second plate is a diffraction plane.

20. The method of claim 11 wherein each of the blocks is a filter.

21. A lithography method for improving contrast comprising the following steps:
providing a light source;
providing a first plate comprising a ring-shaped region by taking a center of the first plate as a center point, the ring-shaped region comprising at least one opening, and the first plate rotating according to at least one angular velocity;
providing a mask having patterns on it;
providing a second plate comprising at least one block corresponding to the opening, and the second plate rotating according to the same angular velocity as the first plate; and
performing an exposure process such that zero order light diffracted by the mask is hindered by the block.

22. The method of claim 21 wherein the first plate is positioned underneath the light source, the mask is positioned underneath the first plate, and the second plate is positioned underneath the mask.

23. The method of claim 21 wherein the light source is an on-axis illumination light source, and the light source is a circular illumination.

24. The method of claim 21 wherein the light source is an off-axis illumination light source, and the light source comprises an annular illumination, a dipole illumination, a tripole illumination, or a quadruple illumination.

25. The method of claim 21 wherein the first plate is a coherent plane.

26. The method of claim 21 wherein the opening is in a slit shape or in a circular shape.

27. The method of claim 21 wherein the center of the first plate is not light transmitting.

28. The method of claim 21 wherein each of the patterns comprises a contact hole pattern, a trench pattern, a metal line pattern, an island pattern, a memory cell pattern of a memory array, or a logic cell pattern of a logic circuit.

29. The method of claim 21 wherein the second plate is a diffraction plane.

30. The method of claim 21 wherein the block is a filter.
